(19) United States
(12) Patent Application Publication
(10) Pub. No.: US 2011/0245950 A1
(43) Pub. Date: Oct. 6, 2011

(54) VEHICLE BODY STRUCTURE AND METHOD FOR MAKING SAME

(75) Inventor: Keith A. Overton, Columbus, OH (US)

(73) Assignee: CVG MANAGEMENT CORPORATION, New Albany, OH (US)

(21) Appl. No.: 13/080,656

(22) Filed: Apr. 6, 2011

Related U.S. Application Data
(60) Provisional application No. 61/321,155, filed on Apr. 6, 2010.

(51) Int. Cl. G06F 19/00; B62D 21/00; B62D 65/02; G06F 17/50

(52) U.S. Cl. 700/98; 296/193.01; 700/117

(57) ABSTRACT

A system and method of design and construction of an interlocking vehicle body structure is provided. Each of the braces can be laser or water cut to enhance efficiency, and accuracy, of the design. Additionally, the braces can be equipped with notches, slots or tabs as appropriate so as to effect ease of construction and installation.

### CROSS-REFERENCE TO RELATED APPLICATIONS

This application claims the benefit of U.S. Provisional Patent application Ser. No. 61/321,155 entitled “VEHICLE BODY STRUCTURE AND METHOD THEREOF” and filed Apr. 6, 2010. The entirety of the above-noted application is incorporated by reference herein.

### TECHNICAL FIELD

The innovation relates generally to the field of vehicle construction and, more particularly, to an efficient and cost effective type and method of vehicle body structure design and construction that utilizes interlocking ribs and stringers to achieve improved performance and cost savings.

### BACKGROUND

Automobile and truck body framing is traditionally constructed of a plurality of stamped metal panels, which are most often welded or otherwise fastened to one another to form subassemblies. The subassemblies are then assembled into a final body structure of the vehicle. These conventional processes require very expensive tooling to produce such parts, making it economically infeasible to have short production runs of vehicles, and nearly certainly make it cost-prohibitive to manufacture unique or “one-off” designs. A distinctive feature of such conventional construction is that the “A surface,” which defines the final outside finish surface of the structure, is part of the framing and therefore, integral to the strength and rigidity of the design.

Alternatively, some vehicle bodies are built with “space frame” technology. Space frame design is based upon specific repeating patterns to create combined strength from the natural support of smaller, simple structures. For example, many traditional space frame designs use a multitude of triangular constructs to create a larger item that holds together without a need for additional structural elements. Still other traditional patterns employ tetrahedrons or additional geometric shapes, also placed in a repetitive formation to reinforce an overall structure.

Frequently, space frame design will utilize bent or curved members, often tubes, to achieve an integral structure. However, as the frame is particularly engineered to a very specific shape, and the strength of the shape depends on the tension and compression that exists between different specific shapes, it is difficult and expensive to re-design space frames for any change in external body structure, often requiring an entirely re-engineered space frame in order to accommodate even minor body changes. For at least this reason, vehicle design changes are infrequent due to the time and expense involved in implementing the underlying support structure. There is a need in the art for an efficient and low cost alternative to space frame and other traditional subassembly technologies.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system (and corresponding method) that facilitates design and construction of an interlocking vehicle body structure. In aspects, the body structure can be constructed from individually straight-shaped, flat “stringers,” braces or ribs. Rather than stamping, the braces can be laser or water cut to enhance efficiency, and accuracy, of the design. A subset of the braces can be equipped with notches or tabs as appropriate so as to effect ease of construction and installation. In addition to brace design (e.g., length, width, thickness, etc.), the notches and tabs in each brace can be strategically designed by the innovation so as to enhance efficiency and to lower cost (e.g., reduction of waste). Further, the braces can be etched or marked with other indicia so as enable efficient and correct construction.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example block diagram of a system that facilitates design of a vehicle outer and inner structure in accordance with aspects of the innovation.

FIG. 2 illustrates an alternative view of the example system in accordance with aspects of the innovation.

FIG. 3 illustrates an example flow chart of procedures that facilitate design of an interlocking vehicle structure in accordance with an aspect of the innovation.

FIG. 4 is an elevated perspective view, partially in “see-through” format, of an embodiment of the innovation.

FIG. 5 is an elevated perspective view of another embodiment of the innovation.

FIG. 6 is a partially “see-through” elevated perspective view of the embodiment of FIG. 5.

FIG. 7 is an elevated perspective view of example external vehicle skins, also known as “A surfaces” as used in an embodiment of the innovation.

FIG. 8 is another elevated perspective view of the embodiment of FIGS. 5 and 6.

FIG. 9 is another partially “see-through” elevated perspective view of an embodiment of the innovation.

FIG. 10 is another partially “see-through” elevated perspective view of a portion of an embodiment of the innovation.

FIG. 11 is another elevated perspective view of a portion of an outside surface of an embodiment of the innovation.

FIG. 12 is another elevated perspective view of a portion of an outside surface of an embodiment of the innovation.

FIG. 13 illustrates a block diagram of a computer operable to execute the disclosed architecture of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, components are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers. In other aspects, a system can be a number of tangible parts, for example, a plurality of inter-connectable “stringers,” braces or ribs.

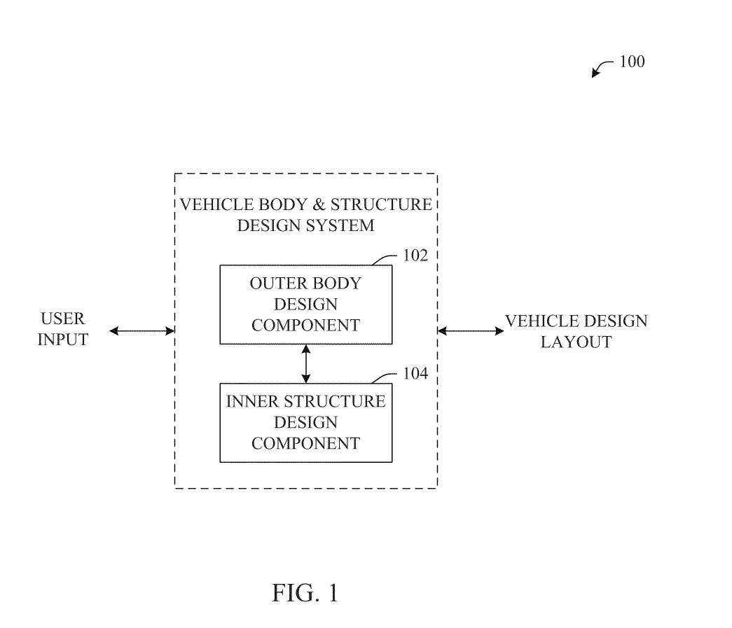

Referring initially to the drawings, FIG. 1 illustrates an example block diagram of a system 100 that facilitates design of a vehicle body and structure thereof. Generally, the system 100 can include an outer body design component 102 and an inner structure design component 104, each of which will be described in greater detail infra. It will be understood that the outer body design component 102 can be illustrative of most any CAD (computer-aided design) or CADD (computer-aided design and drafting) system. It will be understood that a CAD system employs the use of computer technology for the process of design and design-documentation. Similar to CAD systems that describe a process of drafting with a computer, CADD software provides input-tools for the purpose of streamlining design processes such as drafting, documentation, and manufacturing processes. Once completed, CAD and CADD systems generate electronic data files which can most often be printed or employed for other manufacturing operations.

It will be understood that CAD- and CADD-based output can include more than solely two-dimensional shapes. For instance, the output of the outer body design component (e.g., CAD or CADD system) 102, can include materials, manufacturing processes, dimensions, etc. As well, many output files include three-dimensional representations of objects (e.g., vehicle A surfaces).

Continuing with a discussion of FIG. 1, the inner structure design component 104 is capable of receiving the output of an outer body design component (e.g., 102) and thereafter transforming the outer body data into a design of an inner structure that includes a variety of interlocking (or connectable) stringers, braces or ribs. It will be appreciated that this design differs from space frame technology in that the design need not employ a series of specific shapes so as to establish rigidity. As well, all, or some of the braces can be equipped with strategically positioned tabs and/or notches so as to effect ease of installation. Furthermore, the tabs and/or notches can include labels (or other indicia) so as to assist in assembly. Ultimately, the inner structure design component 104 is capable of communicating with manufacturing processes and apparatuses so as to effect efficient and cost effective manufacture of the braces. These, and other, features can be facilitated by way of the inner structure design component 104.

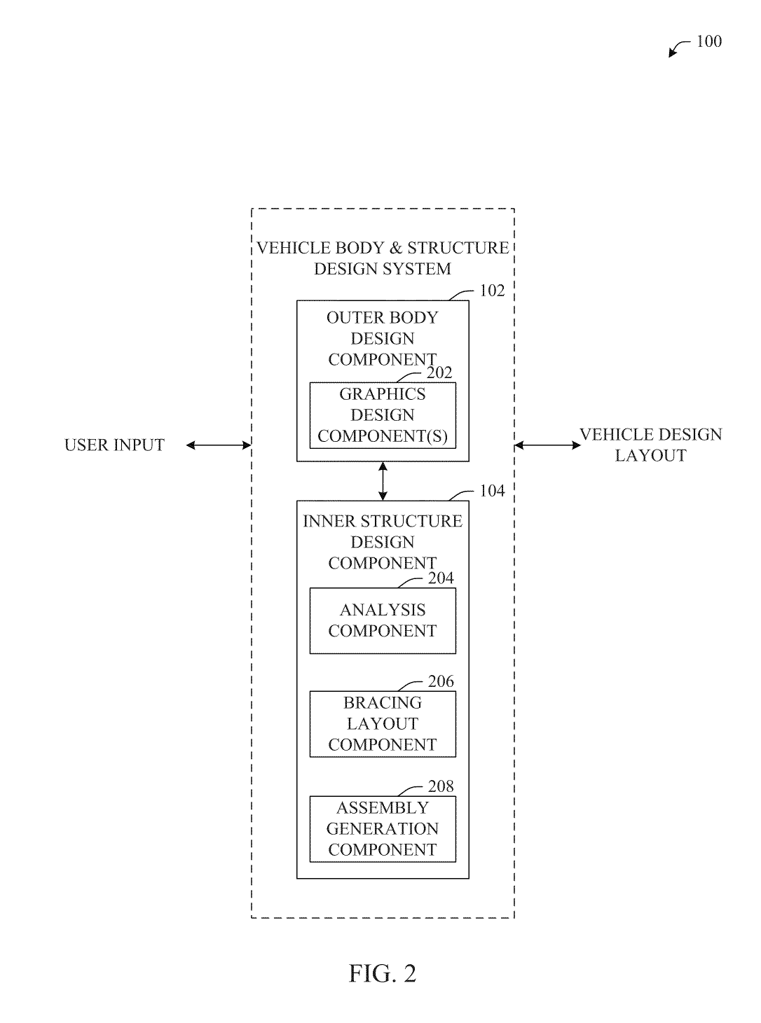

Turning now to FIG. 2, an alternative example block diagram of a vehicle body and structure design system 100 is shown. As illustrated, the outer body design component 102 can include graphics design component(s) 202. These graphics design component(s) 202 can include CAD- or CADD-based systems that facilitate generation of A surfaces of a vehicle's outer body (e.g., long-haul truck body).

In this example, once an outer vehicle surface (e.g., skin) is designed, the data that represents the A surfaces can be input into the inner structure design component 104. As described supra, the data can be representative of the sizes, shapes, thicknesses, materials, placements, tolerances, etc. of each of the surfaces. As shown in FIG. 2, the inner structure design component 104 can include an analysis component 204, an assembly generation component 206 and a bracing layout component 208—each of these components can work in conjunction with each other to establish a vehicle design layout in accordance with the innovation.

As shown, the analysis component 204 can receive the data input from the outer body design component 102. Accordingly, the analysis component 204 can evaluate the A surface layout, apply industry-standard (or other preferred) engineering protocols together with the bracing layout and assembly generation components 206, 208. In conjunction, these sub-components 204, 206, 208 can transform data that defines the A surface(s) into a sub-structure or inner structure of interconnected braces.

The bracing layout component 206 can generate a configuration of interconnected braces of a determined material, thickness, strength, etc. so as to meet or exceed a desired rigidity, for example, to meet or exceed regulated crash test requirements. Among other criteria, the bracing layout component 206 can design the physical dimensions (height, length, thickness, material type, etc.) of each brace. Additionally, the layout component 206 can strategically place a tab(s) and/or notch(es) (and/or slot(s)) where appropriate so as to enable construction of a suitable structure system, e.g., in compliance with a desired or regulated criterion.

The assembly generation component 208 is capable of tagging each of the braces as appropriate so as to effect efficient and proper assembly of each of the braces. For example, each tab and/or notch (and/or slot) can be scribed or equipped with some indicia that identifies how to assemble the structure. More particularly, the indicia can identify where to apply a brace as well as to, in what order, to apply braces when constructing an inner body structure. It is to be understood that the inner structure design component can be capable of communicating directly with manufacturing machines or the like so as to seamlessly manufacture appropriate members based upon the design characteristics.

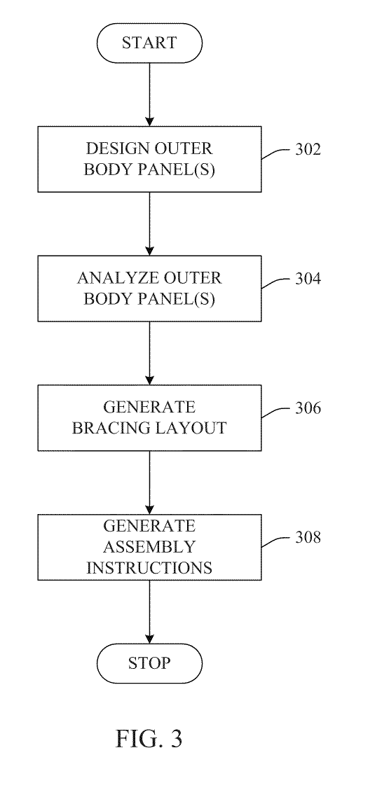

FIG. 3 illustrates a methodology of designing an interlocking vehicle structure in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 302, the outer body panels can be designed. For example, as illustrated in FIGS. 1 and 2, software components can be employed to assist in the transformation of a user input into a graphical design of a vehicle body. As described supra, CAD- and CADD-based components can be employed to establish the A surface designs.

Once designed, the data that represents the body panel(s) (e.g., A surfaces) can be analyzed in preparation of brace (or inner structure) design. In examples, industry standard engineering principles and protocols can be used to evaluate the surfaces and to facilitate structure (e.g., stringer, brace and/or rib) design. A layout of the bracing can be generated at 306—for example, placement of tabs, slots, notches, etc. can be established.

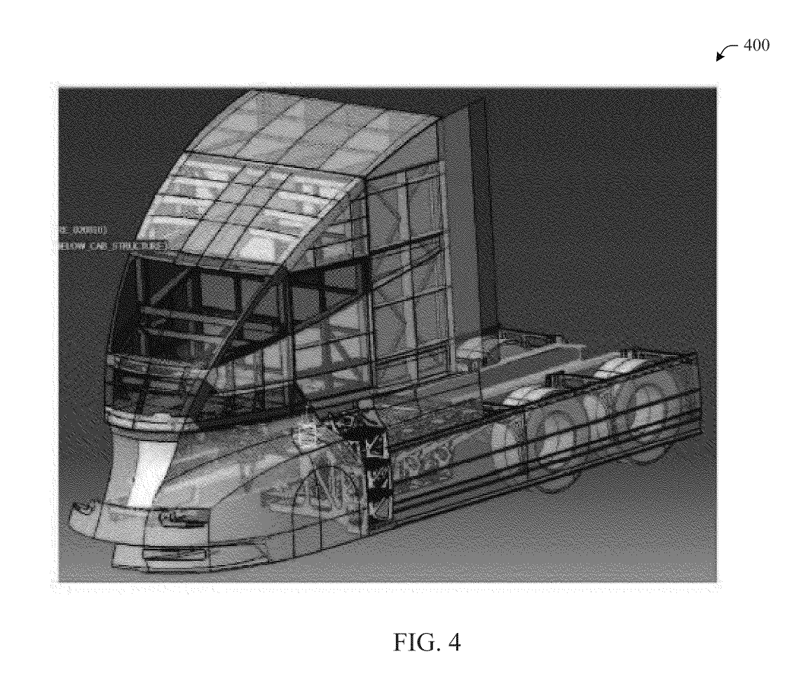

Assembly instructions can be generated at 308. Alternatively, or in conjunction, at 308, braces can be marked or otherwise scribed with indicium that assists in assembly of the braces or structure. In this example, a step-by-step set of instructions can be established so as to assist in construction of an interlocking structure assembly. Physical characteristics of the structure assembly will be better understood upon a review of the figures that follow. In particular, while FIGS. 1-3 are directed to systems and methods of designing in interlocking structure for A surfaces, FIGS. 4-13 illustrate example physical structures that convey features, functions and benefits of the innovation. The distinguishing factors that separate the innovation from conventional frame design as well as conventional space frame technologies will be understood upon a review of the figures that follow.

As described herein, the innovation deviates from the tradition of using either stamped body panels or space frame design in vehicle structures. Rather, the innovation discloses use of a series of interlocking braces, ribs and stringers, beneath a relatively thin outer vehicle skin (e.g., A surfaces). As will be understood, the unique structure design disclosed herein can achieve safety, strength, and rigidity.

The interlocking structure itself can be constructed from a plurality of laser-cut, water-cut, or otherwise cut braces, ribs and stringers. These structure components can be manufactured of, or cut from, flat metal plate. Such plate is often, but not always, 6000 series aluminum alloy plate in thicknesses that typically ranges from 1/16 of an inch thickness for small members, to ⅛ inch, ¼ inch, or even thicker plate, for larger members. As will be understood upon a review of this specification, these flat plates may be cut into various curved shapes, thus obviating many of the difficulties associated with the bending of flat plate and/or metal tubes. Because all members can be cut from flat plates, cutting is relatively easy and precise.

While metal structure components are disclosed herein, it is to be appreciated that most any suitably rigid material can be employed in alternative aspects without departing from the spirit and scope of this innovation. In other words, it is to be understood that, in alternative aspects, members (e.g., braces, stringers or ribs) need not be constructed of metal so long as the structure is able to meet a desired, mandated or regulated strength, e.g., crash test. Similarly, while flat plate components are disclosed in the examples, it is to be understood that other aspects can employ tubes, bent members or the like in addition to the flat plate interlocking structures. These alternatives are to be included within the scope of the innovation described and claimed herein.

The braces, ribs and stringers may additionally be cut with corresponding tabs and notches (or slots), where one member may run into another, or with corresponding and cooperating notches at a place where one member may cross another. These mechanical interlocks can strengthen optional welds that may be made at such points, and additionally, act as layout aids. As described above, each of the tabs, notches, slots, etc. can be equipped with indicium (e.g., letters, numbers, symbols) that directs proper assembly.

The presence of necessarily cooperating treatments (e.g., tabs, slots and notches) creates fixed dimensions where parts are held in place, thus tending to fix the point at which members are attached. It will be appreciated that this design and assembly functionality can enhance assembly and decrease assembly errors. Since parts may be mechanically assembled, e.g., pre-weld, the necessity of repeated measurement and careful alignment prior to making permanent welds is greatly decreased. While welding is described herein, it is to be understood that welding is optional and is not intended to limit the scope of the innovation and claims appended hereto. Rather, structures can be assembled without any additional attachment beyond, tab-notch (or slot) assembly. Other aspects can employ hardware or other adhesive (or welding/soldering) means as appropriate or desired.

Referring now to FIG. 4, an example interlocking structure assembly 400 is illustrated in connection with a long-haul truck body. As shown, a plurality of interlocking flat-plate braces, stringers and ribs can be interconnected beneath the A-surface(s) of the body (or outer vehicle skin). One advantage of the versatile interlocking structure system is that it creates a very high degree of freedom in designing the outer skin of a vehicle. Due to the flexibility of the method to design extremely forward-thinking and aerodynamic external shapes, a designer can effectively be as creative as one desires. For example, designs can be generated so as to be aesthetically pleasing, to enhance aerodynamics (and fuel-savings), to establish visible brand recognition, etc. It is however, to be emphasized that the exact configuration of the outside surface, or “A surface,” of a vehicle is not to limit the scope of the subject specification. One feature of the innovation is directed to a means of designing a body inner structure that can accommodate a wide plurality of “A surface” design characteristics.

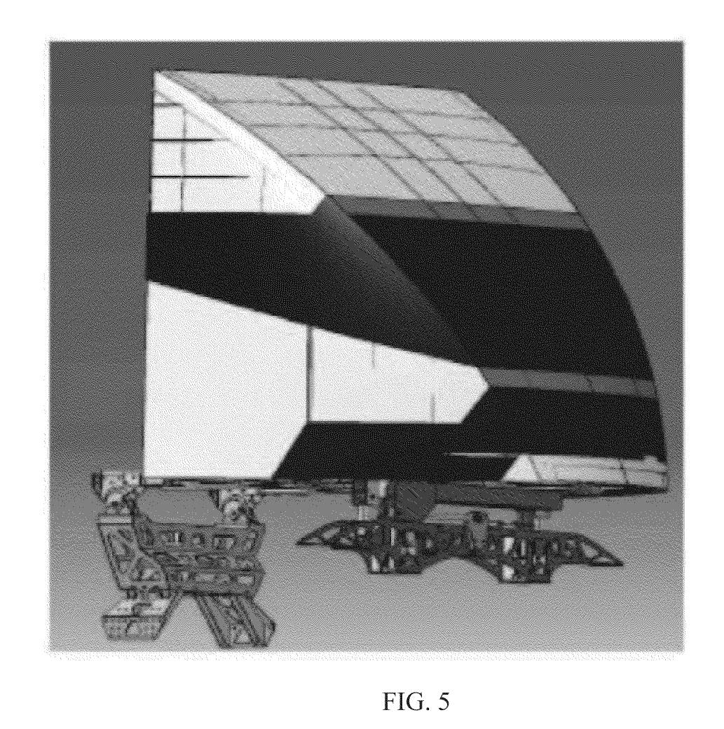

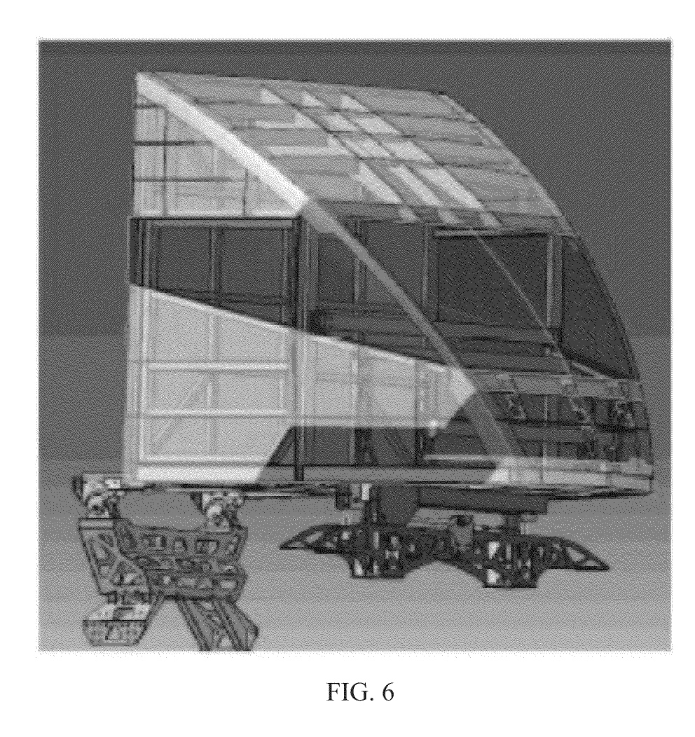

Referring to the example of FIG. 5, after the skin, or “A surface,” is designed to satisfaction, often utilizing wind tunnel or other design functionalities, the design of the structure may be completed. FIG. 6 illustrates an underlying structure of the example skin or A surface of FIG. 5. It is to be understood that, as used in this disclosure, the words “stringer(s),” “brace(s),” “rib(s)” and “member(s)” are used interchangeably, and without restriction as to direction in which the structures named may lie, and without any restriction as to the size, shape, material, thickness, or load-bearing requirements of such structures.

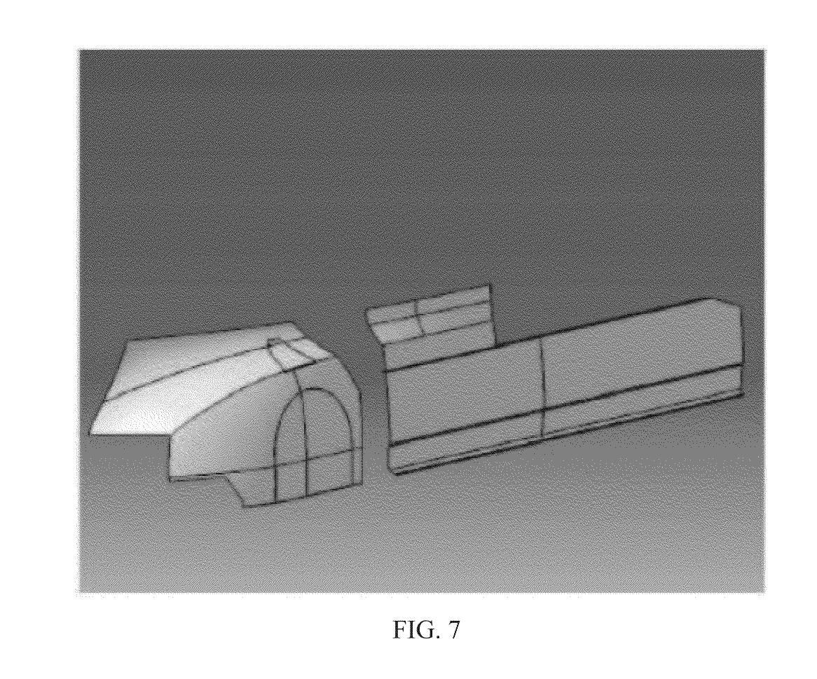

Referring now to FIG. 7, example A surfaces (or skins) are shown. It is to be understood that the innovation enables, efficient design of an interlocking structure that is capable of supporting most any design of vehicle A surface as desired. As described, the innovation discloses both, a method and system of designing an interlocking structure as well as the structure itself, e.g., stringers, braces and ribs thereof.

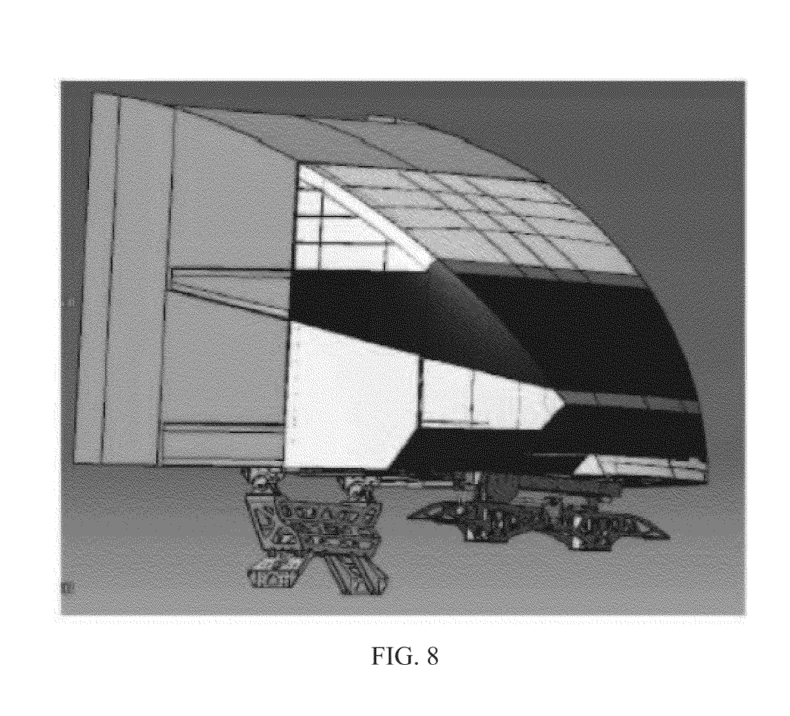

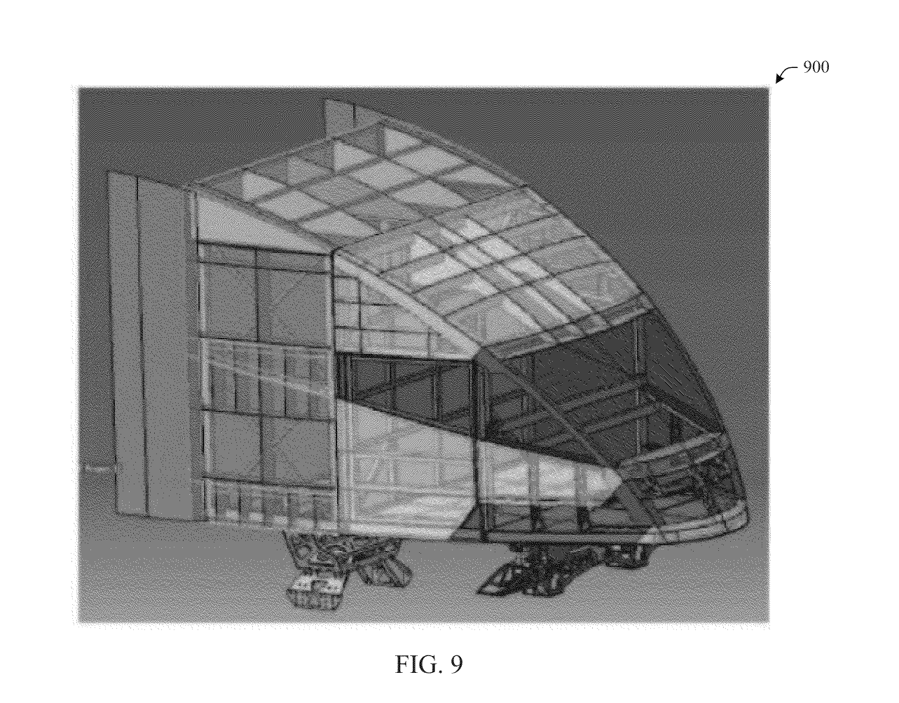

Another example is provided in FIGS. 8 and 9 to add perspective, and not limitation, to the innovation. As shown in FIG. 8, an outer skin can be designed and generated, e.g., via computer-implemented systems. Similarly, as illustrated in FIG. 9, a system of interconnected stringers can be designed so as to optimally or efficiently design the underlying structure 900 shown in FIG. 9. As will be understood, the plurality of stringers of structure 900 can be generated to accommodate the example skin of FIG. 8.

In part, the innovation's design process can involve identification of major structures in the skin, such as windows and doors, and the placement of stringers supporting the edges, or near edges. This can be accomplished via an analysis component as shown in FIG. 2 supra. The stringers can be sized according to the engineering demands and loads of the vehicle structures. Additional consideration is given so that major structures are placed to provide support for other appurtenances, by way of example only, so that seats later installed will be properly supported, or that engines, wheel trucks, or the like will be sufficiently joined to the vehicle frame, as may be seen in FIG. 8.

Because the stringers and ribs can be cut, on a curve if necessary or appropriate, from flat plate, the innovation can facilitate relative ease in conforming the basic vehicle shape and structure to fit whatever demands are placed by curvature or design of the outside skin. After the major structures, stringers and ribs, are designed, including the aforementioned tabs and notches (and/or slots) joining them together, the innovation may add additional ribs and stringers, as can be well seen in FIG. 9. When the design is complete, the stringers and ribs may be laser, water, or otherwise cut from metal of appropriate type and thickness.

It will be appreciated that since the ribs and stringers are cut from flat plate, the various pieces may be compactly stacked for transport to an assembly area. In an assembly area, the major stringers and ribs are connected, using the preplanned and cooperating ribs and notches. In aspects, once interconnected, the members can be welded or otherwise fixedly attached to enhance strength.

As discussed above, the pre-notching (and optional labeling) of these structures simplifies assembly and decreases the need for highly accurate measurements during assembly, and simplifies holding pieces in proper orientation during the welding process, if appropriate. As planned during the design phase, if desired, minor ribs and stringers may then be added and welded in position according to the plan, to further strengthen the design and to add connection points as needed. Similarly, structures can be retrofitted or updated at a later time as desired or need by modeling the member strength characteristics in view of a desired result or strength requirement.

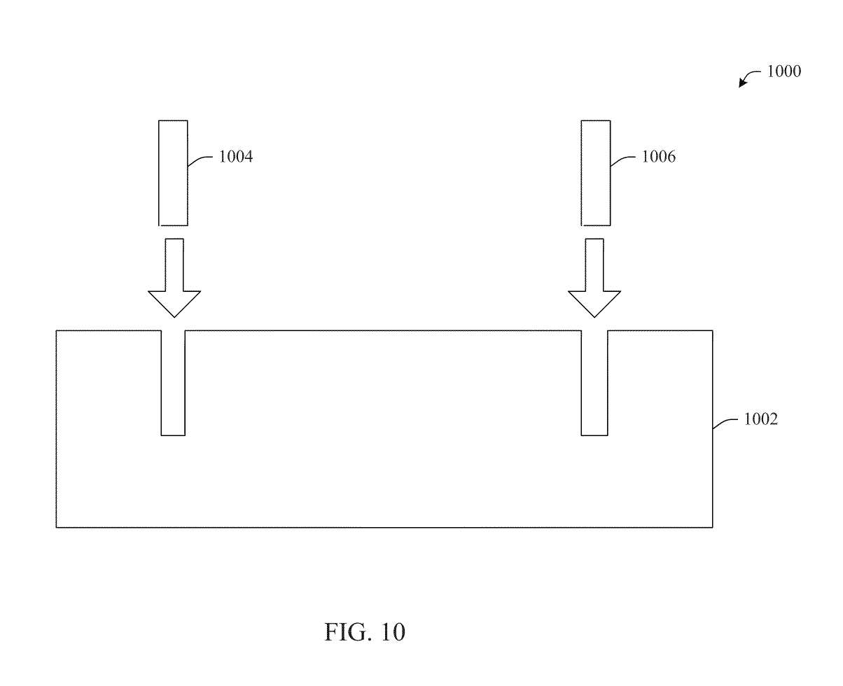

FIGS. 10, 11 and 12 are provided to add perspective to the innovation and are not intended to limit the scope of the innovation in any manner. Rather, the figures are provided to show some example configurations of notches and slots as can be used in accordance with the innovation. It is to be appreciated that, although a specific number, size and placement of notches and slots are shown, other aspects can be employed that include more or fewer of each without departing from the spirit and/or scope of the features, functions and benefits described herein.

Referring first to FIG. 10, an example notched brace assembly 1000 is shown. In particular, one member 1002 can be equipped with notches that are capable of accepting the side profile of other members 1004, 1006. It will be understood that, as desired, the size and profile of the notches can be specifically designed in accordance with the appropriate mating braces, for example, according to a desired strength or rigidity plan. Although not shown, it will be appreciated that cooperating notched braces can also be connected in alternative embodiments.

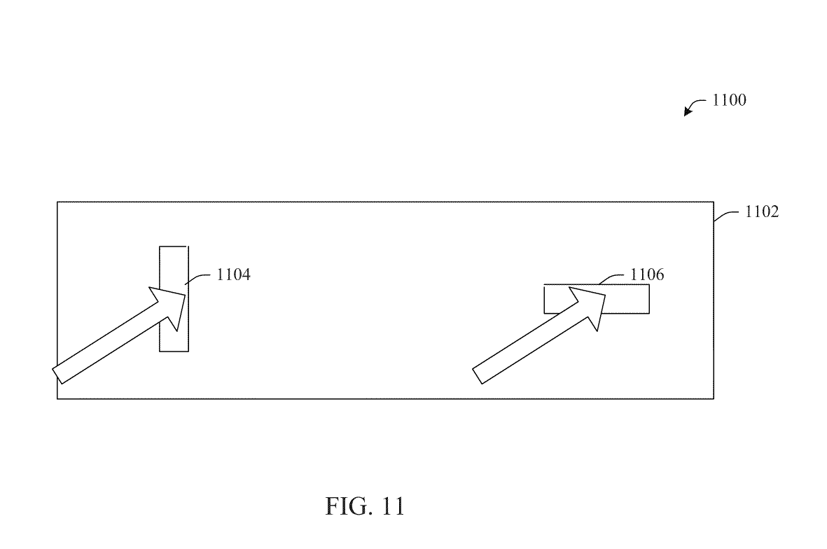

FIG. 11 illustrates a slotted example assembly 1100. Here, as shown, a brace 1102 can be equipped with one or more slots that are capable of accepting braces of slightly smaller profile than the size of an aperture (or slot). The example of FIG. 11 illustrates two separate slots, one vertical 1104 and one horizontal 1106. As stated with regard to FIG. 10, the example of FIG. 11 is an example and other configurations can be employed without departing from the spirit and/or scope of the innovation and claims appended hereto. While a rectangular slot is shown, it is to be understood that alternatively shaped slots can be employed in other aspects. For example, slots can be round, equipped with a locking notch, etc. All variants of the slot shape/design are to be included within the scope of the innovation. Similarly, notches of FIG. 10 can also bear different profiles than those shown—all of which are to be included within the scope of this innovation.

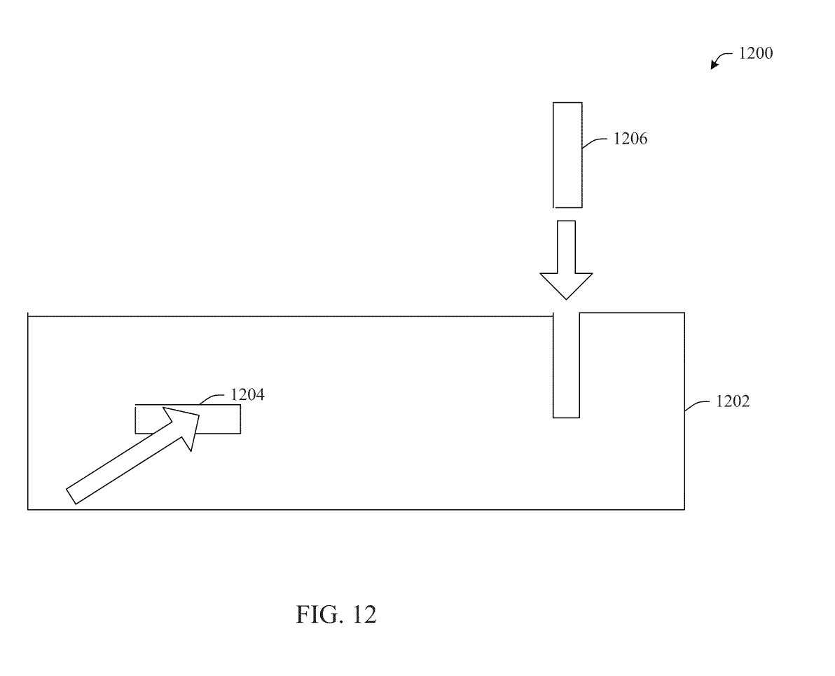

FIG. 12 is provided to illustrate that a mixed or combination slot/notch assembly 1200 can be employed as desired. As shown, a brace 1202 can be equipped with a slot 1204 as well as a notch 1206 that are configured to accept braces having a cross section smaller (e.g., slightly smaller) than the aperture 1204 or slot 1206 as designed. Again, the examples provided in FIGS. 10, 11 and 12 are examples only—it is to be understood that other examples exist that are configured differently without departing from the spirit and/or scope of the features, functions and benefits of the innovation.

As described herein, one advantage of the innovation is the ease with which outer skin (and inner structure) design and changes to a design can be accommodated. Since tooling for metal stampings are not required, a reconfiguration of the outer skin of a vehicle often results in minimal effort to effect corresponding structure design changes. Additionally, since computer assisted design can be used to design the stringers and ribs of the system, e.g., as shown in FIGS. 1-2, there is relatively little cost in changing structure. Thus, the innovation can facilitate an advantage of added strength that the interlocked stringer and rib system gives to the overall structure.

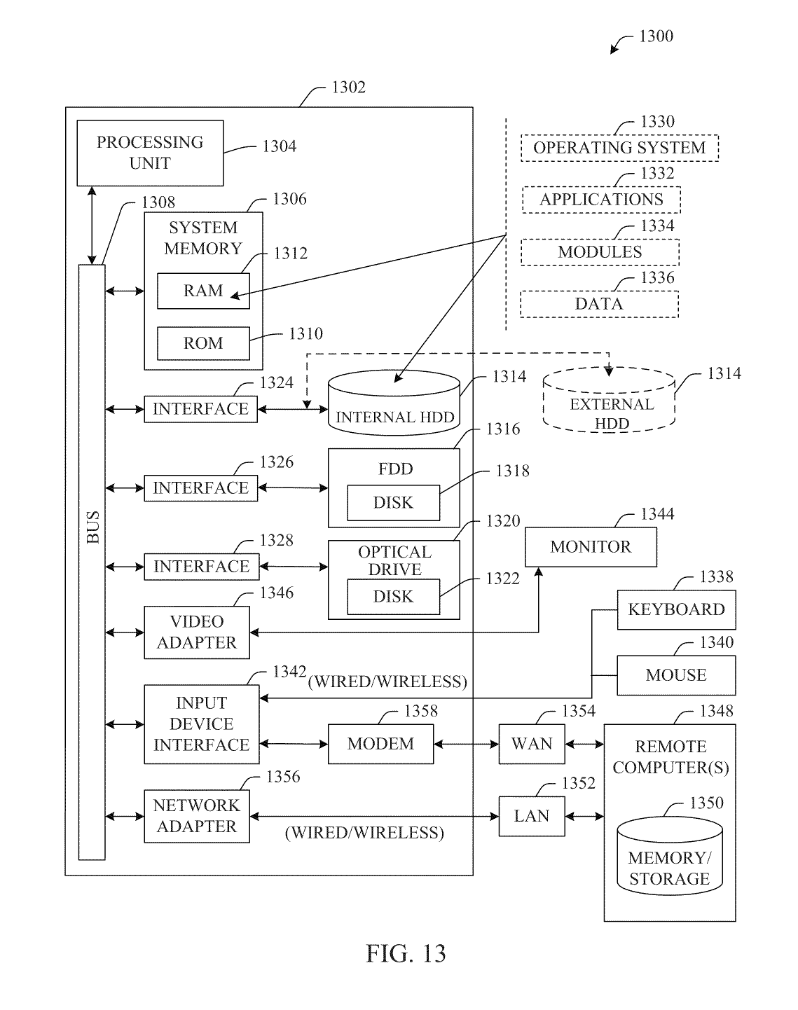

Referring now to FIG. 13, there is illustrated a block diagram of a computer operable to execute the disclosed architecture. In order to provide additional context for various aspects of the subject innovation, FIG. 13 and the following discussion are intended to provide a brief, general description of a suitable computing environment 1300 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 13, the exemplary environment 1300 for implementing various aspects of the innovation includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 may also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is appreciated that the innovation can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc.

A monitor 1344 or other type of display device is also connected to the system bus 1308 via an interface, such as a video adapter 1346. In addition to the monitor 1344, a computer typically includes other peripheral output devices (not shown), such as speakers, printers, etc.

The computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which may connect to a global communications network, e.g., the Internet.

When used in a LAN networking environment, the computer 1302 is connected to the local network 1352 through a wired and/or wireless communication network interface or adapter 1356. The adapter 1356 may facilitate wired or wireless communication to the LAN 1352, which may also include a wireless access point disposed thereon for communicating with the wireless adapter 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wired or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates vehicle structure, comprising:
a processor that executes computer executable instructions stored on a computer readable storage medium to implement the following components;
an inner structure design component that evaluates an outer vehicle design and thereafter models an inner vehicle structure that comprises a plurality of interconnected members, wherein at least a subset of the interconnected members comprise a notch or a slot capable of accepting a disparate one of the plurality of members.

2. The system of claim 1, further comprising an analysis component that evaluates the outer vehicle design based at least in part upon industry standard engineering principals.

3. The system of claim 2, further comprising a bracing layout component that identifies configuration, placement and interconnection of each of the plurality of members based at least in part upon a desired rigidity and the industry standard engineering principals in view of the evaluation.

4. The system of claim 3, further comprising an assembly generation component that marks each of the plurality of members with indicia that facilitates the identified placement and interconnection.

5. The system of claim 3, further comprising an assembly generation component that communicates with a machine that manufactures each of the plurality of members.

6. The system of claim 5, wherein the machine is a laser cutting apparatus.

7. The system of claim 5, wherein the machine is a water cutting apparatus.

8. The system of claim 5, wherein the plurality of members are aluminum alloy members.

9. A system that facilitates vehicle body structure, comprising:
a first member having at least one notch or slot that is strategically positioned in accordance with an overall structure design that comprises a plurality of interconnected members; and
a second member that is sizably configured to be inserted into or through the at least one notch or slot, wherein the overall structure comprises a plurality of interconnected members, at least a subset of which include at least one notch or slot configured to accept another of the subset of interconnected members.

10. The system of claim 9, wherein each of the plurality of members are flat plate members.

11. The system of claim 9, wherein each of the plurality of members are aluminum alloy members.

12. The system of claim 9, wherein the at least one notch or slot is created via laser cutting.

13. The system of claim 9, wherein the at least one notch or slot is created via water cutting.

14. The system of claim 9, wherein each of the plurality of members comprise indicium that facilitates assembly of the overall structure.

15. The system of claim 9, wherein the overall structure is an overall vehicle inner structure that supports an outer vehicle skin.

16. The system of claim 9, wherein the overall structure is not a space frame designed structure.

17. A method of constructing a vehicle inner body structure, comprising:
positioning a first member, wherein the first member includes at least one of a notch or slot;
attachably connecting a second member to the first member by positioning the second member into or through the at least one of the notch or slot; and
repeating notch or slot assembly for a plurality of interconnected members in accordance with the inner body structure.

18. The system of claim 17, wherein each of the first member, second member and plurality of members are flat plate members.

19. The method of claim 17, further comprising welding each of the plurality of interconnected members to a respective member.

20. The method of claim 17, further comprising utilizing indicium on each of the plurality of interconnected members to facilitate proper assembly.
